(19) United States
(12) Patent Application Publication
(10) Pub. No.: US 2018/0359674 A1
(43) Pub. Date: Dec. 13, 2018

(54) SWITCHING CONTROL FOR LOW QUALITY COMMUNICATION SIGNAL

(71) Applicant: Microsoft Technology Licensing. LLC, Redmond, WA (US)

(72) Inventor: David LU, Seattle, WA (US)

(21) Appl. No.: 15/619,980

(22) Filed: Jun. 12, 2017

(51) Int. Cl. H04W 36/32; H04W 36/00

(52) U.S. Cl. CPC H04W 36/32; H04W 36/0083; H04W 36/14; H04W 36/0094; H04W 36/0055

(57) ABSTRACT

Signal quality of a communication signal that is being used to communicate with a hosted speech service is detected. When poor signal quality is detected, switching logic is controlled to selectively switch to a separate communication application or component, such as a telephony component. User interface elements can be provided for user interaction, in the switching process, as well.

### BACKGROUND

Computer systems are currently in wide use. Some computer systems host services. The services can be a wide variety of different types of services, including speech-based services (such as text-to-speech services and speech recognition services).

In some scenarios, users use a user device (which may be mobile devices or other devices) to access the hosted service. In other scenarios, the user of the user device is interacting with an application and the application, itself, accesses the hosted service.

For instance, it may be that the user is interacting with an application (such as a personal assistant application) using voice. The application, itself, accesses a hosted speech service in order to have speech processing performed on the voice inputs provided by the user. By way of example, it may be that the user is providing voice inputs that are commands to the application. The application sends the voice data, representative of the voice inputs, to the speech service for recognition. In another example, the application may be providing textual inputs to the hosted speech service where the textual inputs are synthesized into speech. Speech data, representative of the synthesized speech, is then provided back to the application where it is used to generate an audio output (such as a speech output) to the user.

All of these types of scenarios rely on a communication system that communicates with the hosted speech service. The quality of the communication between the user device and the hosted speech service can vary for a wide variety of different reasons. The bandwidth of the communication system may present quality issues. There also may be environmental conditions or other conditions that result in degraded quality in the communication system being used.

The discussion above is merely provided for general background information and is not intended to be used as an aid in determining the scope of the claimed subject matter.

### SUMMARY

Signal quality of a communication signal that is being used to communicate with a hosted speech service is detected. When poor signal quality is detected, switching logic is controlled to selectively switch to a separate communication application or component, such as a telephony component. User interface elements can be provided for user interaction, in the switching process, as well.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of signal quality detection logic, in more detail.

FIG. 3 is a block diagram showing one example of application/channel switching logic, in more detail.

FIGS. 4A and 4B (collectively referred to herein as FIG. 4) show a flow diagram illustrating one example of the operation of the architecture shown in FIG. 1 in detecting communication signal quality and switching to a different communication component.

FIG. 5 is a flow diagram illustrating one example of the operation of the architecture shown in FIG. 1 in switching to a different communication component that has better signal quality, and in monitoring to switch back to the original communication system, if its signal quality improves.

FIG. 6 is a block diagram showing one example of the architecture shown in FIG. 1, deployed in a cloud computing architecture.

FIGS. 7-9 show examples of mobile devices that can be used in the architectures shown in the previous figures.

FIG. 10 is a block diagram showing one example of a computing environment that can be used in the architectures shown in the previous figures.

### DETAILED DESCRIPTION

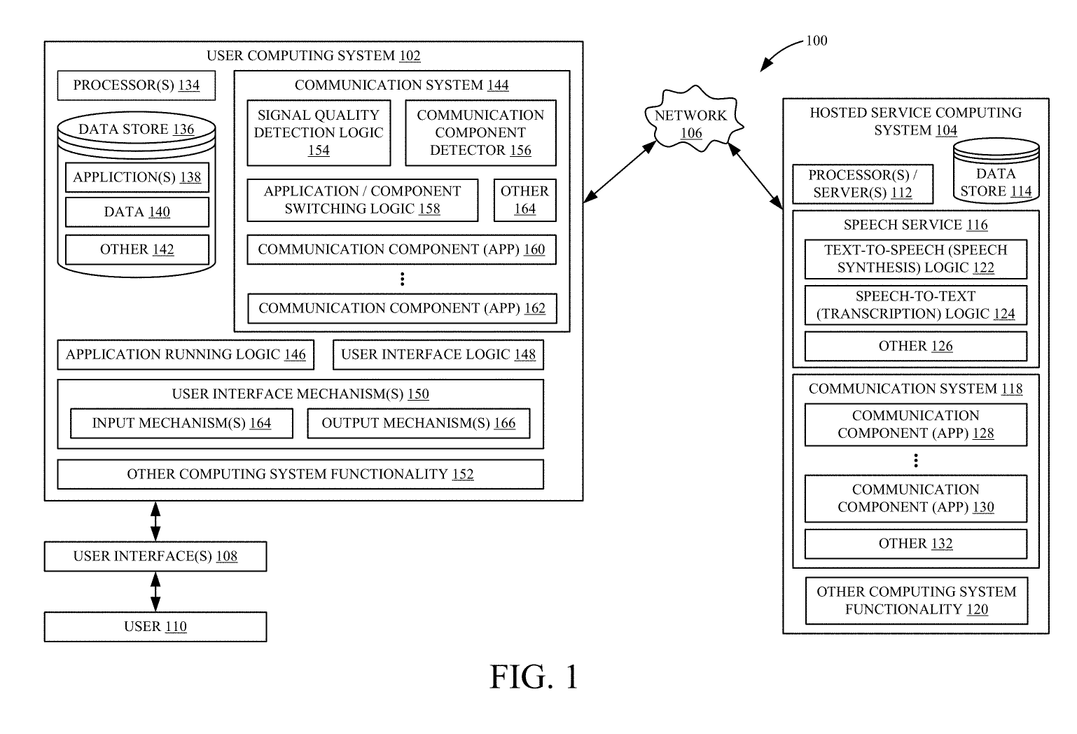

FIG. 1 is a block diagram of one example of a computing system architecture 100. Architecture 100 shows user computing system 102 connected to hosted service computing system 104 over network 106. Network 106 can be a wide area network, a local area network, a cellular communication network, a public switched telephone network, a wireless local area network (such as WiFi), a near field communication network, or any of a wide variety of other networks or combinations of networks.

FIG. 1 shows that, in one example, user computing system 102 generates user interfaces 108 for interaction by user 110. User 110 can interact with items on user interfaces 108 in order to control and manipulate user computing system 102, and some portion of hosted service computing system 104. Hosted service computing system 104 illustratively hosts a service that may be accessed by user computing system 102, or by an application running on user computing system 102, etc.

Before describing the overall operation of architecture 100 in more detail, a brief description of some of the items in architecture 100, and their operation, will first be provided. Hosted service computing system 104 illustratively includes one or more processors or servers 112, data store 114, speech service 116, communication system 118, and it can include a wide variety of other computing system functionality 120. Hosted service computing system 104 illustratively hosts speech service 116 for access by other computing systems, such as user computing system 102. Therefore, in one example, speech service 116 can include text-to-speech (speech synthesis) logic 122, speech-to-text (transcription) logic 124, and it can include a wide variety of other logic 126 for performing speech services.

Communication system 118 illustratively includes a plurality of different communication components (which may be applications or other communication components) 128-130. Hosted service computing system 104 can illustratively use any of the communication components 128-130 in communication system 118 in order to communicate over network 106. Communication system 118 can include a wide variety of other items 132 as well. Communication components 128-130 can also include mechanisms that allow communication over a wide area network, such as the Internet, over a cellular network, over a public switched telephone network, etc.

User computing system 102 illustratively includes one or more processors 134, and data store 136 that can store applications 138, a variety of application or other data 140, and it can include other items 142. User computing system 102 also illustratively includes communication system 144, application running logic 146, user interface logic 148, user interface mechanisms 150, and it can include a wide variety of other computing system functionality 152. Communication system 144 illustratively includes signal quality detection logic 154, communication component detector 156, application/component switching logic 158, a plurality of communication components (or applications) 160-162, and it can include a wide variety of other items 164. User interface mechanisms 150 can include input mechanisms 164 and output mechanisms 166. Input mechanisms 164 can include items such as buttons, switches, touch sensitive screens that display icons or other actuatable elements. Input mechanisms 164 can also include a microphone for receiving speech or other audible inputs. Output mechanisms 166 can include display screens for displaying textual or other visible information, audio output mechanisms, haptic output mechanisms, or other output mechanisms. Other examples of input mechanisms 164 and output mechanisms 166 are provided below.

In operation, application running logic 146 illustratively runs one or more applications 138. The applications can be used to operate on data 140. It may be that an application 138 that is being run by application running logic 146 uses a hosted service (such as speech service 116) hosted by hosted service computing system 104. In that case, the application will use communication system 144 to communicate with speech service 116 in hosted service computing system 104. Communication system 104 may use one or more of the plurality of different communication components or applications 160-162 in order to communicate with hosted service computing system 104. For instance, it may be that one of the communication components or applications 160 is a wireless local area network component (e.g., a Wi-Fi component) that user computing system 102 uses to connect to a wide area network (such as the Internet) for communication with hosted service computing system 104. One of the communication components (or applications) 160-162 may include a telephony component, such as a cellular communication component that uses a cellular network or cellular communication to communicate with hosted service computing system 104. The communication components 160-162 can include a wide variety of other components as well.

The application being run by logic 146 may use the communication system 144 to send data to speech service 116 so that speech service 116 can receive data from the application and perform speech operations (such as speech synthesis, speech recognition and transcription, or other speech operations) on the data. It can return the result of the speech operation (such as data representing an audible synthesis of the data, data representing a transcription of a speech input, etc.) back to user computing system 102 over the desired network 106.

When a user 110 is interacting with user computing system 102 using speech, and when user computing system 102 is having a remote, hosted service perform speech operations, the quality of the communication signal that is communicating the data back and forth from user computing system 102 to hosted service computing system 104 may have a deleterious effect on the user experience. For instance, speech operations usually need relatively high data throughput on the communication channel being used. Therefore, if the signal quality (such as the available bandwidth) is poor, then the latency with which the speech operations are performed may increase. In accordance with one example, communication component detector 156 first detects which communication component 160-162 the application is using to communicate with speech service 116. Signal quality detection logic 154 monitors or detects the signal quality that is encountered using the detected communication component (such as component 160) for communication with hosted service computing system 104. If the signal quality fails to meet a threshold value, or is otherwise determined to be of insufficient quality, then application/component switching logic 158 identifies another communication component 160-162 which may be available, and may have better signal quality. It then performs switching operations that automatically switch, or allow user 110 to switch, the application from using the communication component that is experiencing low signal quality to the newly identified communication component, in an attempt to increase the signal quality being used by the application to access speech service 116. The quality of the communication signal used by the original communication component 160-162 can continue to be monitored, even after the application is switched to another communication component so if the signal quality improves, the application can be switched back to the original communication component.

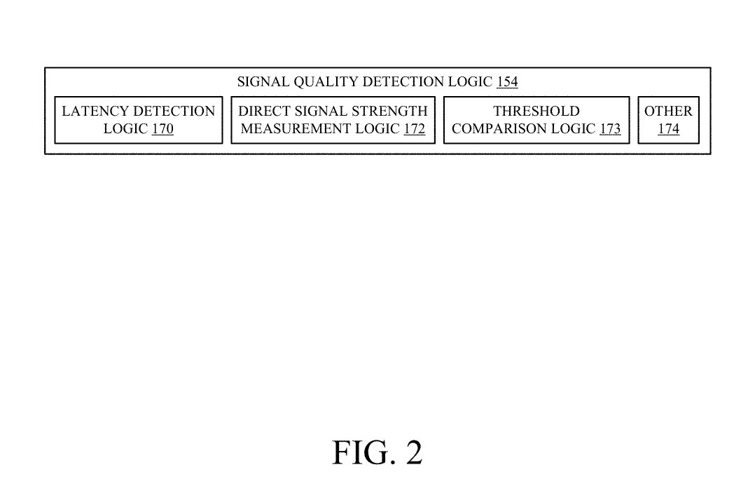

FIG. 2 is a block diagram showing one example of signal quality detection logic 154 in more detail. In the example shown in FIG. 2, logic 154 illustratively includes latency detection logic 170, direct signal strength measurement logic 172, threshold comparison logic 173, and it can include a wide variety of other detection logic 174. Latency detection logic 170 illustratively detects the quality of a communication signal by detecting a latency with which information is transmitted, using that communication component or application, from user computing system 102 to hosted service computing system 104, and back. Thus, it can periodically send a message from user computing system 102 to hosted service computing system 104, and request a response, and measure the latency (or response time) being experienced. Direct signal strength measurement logic 172 can be used to directly measure the quality of the communication signal in other ways, other than latency. For instance, where the communication component being used is a cellular communication component, logic 172 illustratively measures the strength of the cellular signal, directly, without needing to measure latency. The signal quality can be detected in a wide variety of other ways as well. The signal characteristic that is detected and is indicative of signal quality, can be compared to a characteristic threshold value by threshold comparison logic 173 to determine the quality of the signal based on whether it meets the threshold.

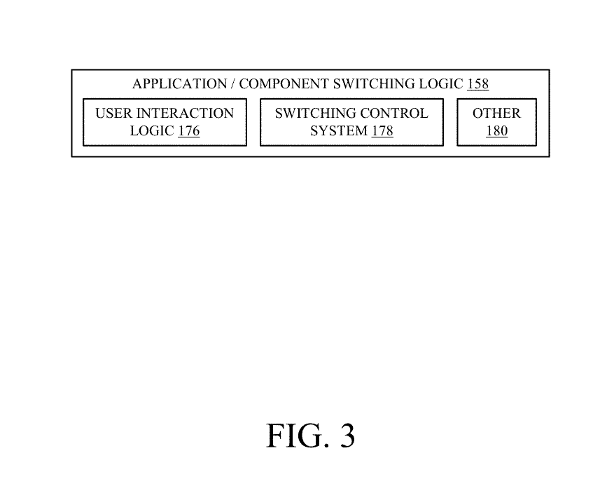

FIG. 3 is a block diagram showing one example of application/component switching logic 158 in more detail. In the example shown in FIG. 3, logic 158 illustratively includes user interaction logic 176, switch control system 178, and it can include a wide variety of other items 180. Where signal quality detection logic 154 determines that the signal quality of the communication component currently being used is insufficient, then user interaction logic 176 can generate a user interaction element on one of user interfaces 108 to indicate to user 110 that the signal quality being experienced is relatively low, and asking whether the user wishes to switch to a different communication component. For example, if the user is using a wireless local area network that connects to a wide area network through a access point, (e.g., a Wi-Fi communication component), and the signal quality (e.g., available bandwidth) is low (e.g., the latency is high), then user interaction logic 172 may ask the user whether the user wishes to switch to a telephony communication application (such as a cellular application) that wraps, or otherwise interacts with, speech service 116. This can be provided on a user interface display with a user actuatable element that allows the user to indicate his or her answer. If the user indicates in the affirmative, then user interaction logic 176 detects this. In response, switching control system 178 illustratively controls communication system 144 to switch from the currently used communication component, to the suggested communication component. The switch can also be done automatically, without needing user input.

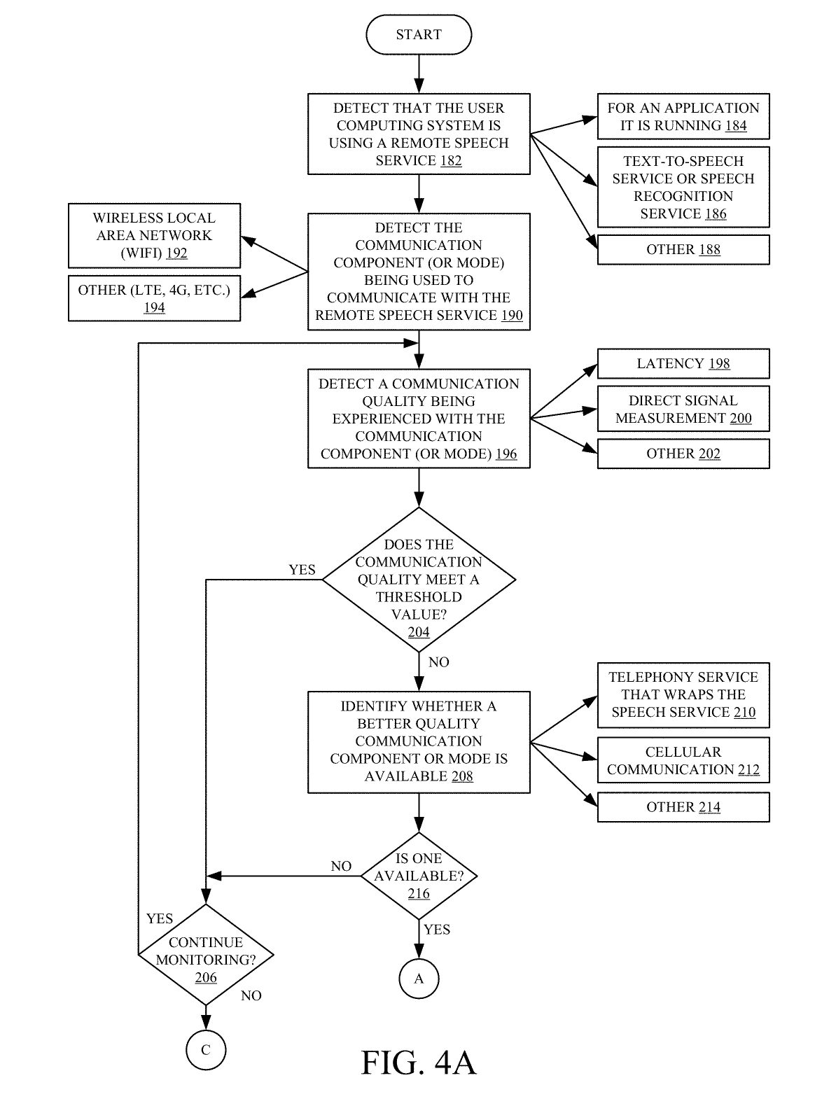

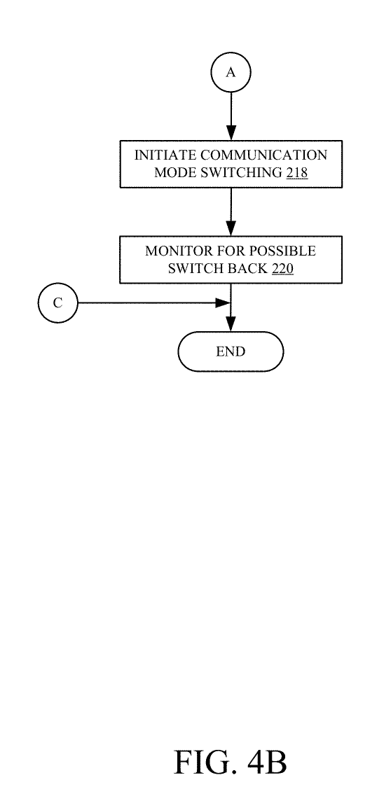

FIGS. 4A and 4B (collectively referred to herein as FIG. 4) show a flow diagram illustrating one example of the operation of architecture 100 in detecting whether the communication signal quality is low enough to suggest switching to another communication component. It is first assumed that application running logic 146 is running an application which is using the remote speech service 116 hosted by hosted computing system 104. This is indicated by block 182 in the flow diagram of FIG. 4. For instance, it can be an application, such as a personal assistant application, that is running and that is receiving speech commands or providing an audio output. This is indicated by block 184. The speech service can be a text-to-speech service or speech recognition service. This is indicated by block 186. The interaction with the speech service can be detected in other ways as well, and this is indicated by block 188.

Communication component detector 156 can then detect the particular communication component (or application) 160-162 that the application is using to communicate with the remote speech service 116. This is indicated by block 190 in the flow diagram of FIG. 4. For instance, it may be a wireless local area network (Wi-Fi) component as indicated by block 192, it might be another component, such as a fourth generation (4G) component, a long-term evolution (LTE) component or other components. This is indicated by block 194.

Signal quality detection logic 154 then detects the communication quality being experienced by the identified communication component. This is indicated by block 196. This can be done, as described above, by detecting the communication latency 198, by performing direct signal measurement 200, or in a variety of other ways 202. Threshold comparison logic 173 then determines whether the communication quality meets a threshold value. This is indicated by block 204. If so, then it is determined whether the signal quality detection or monitoring should be continued, as indicated by block 206 (e.g., whether the user is still using the application that is communicating with speech service 116). If monitoring is to continue, processing reverts to block 196.

If, at block 204, it is determined that the communication signal quality does not meet the threshold level, then signal quality detection logic 154 determines whether a higher quality communication component or mode of communicating is available. This is indicated by block 208. For instance, if the user is using a Wi-Fi communication component, then signal quality detection logic 154 can determine whether a telephony communication component is available, and whether service is available for that component. The telephony component may be a telephony service that wraps the speech service 116 being accessed by user computing system 102. This is indicated by block 210. It may be a cellular communication component 212, or it can be any of a wide variety of other communication components that have better communication signal quality. This is indicated by block 214.

If such a component is available, as indicated at block 216, then application/component switching logic 158 initiates the communication mode switching processing, in order to switch to the new communication component. This is indicated by block 218. Signal quality detection logic 154 also continues to monitor the original communication component to see whether the signal quality improves, and therefore to see whether it should switch back to that communication component in order to communicate with speech service 116. This is indicated by block 220.

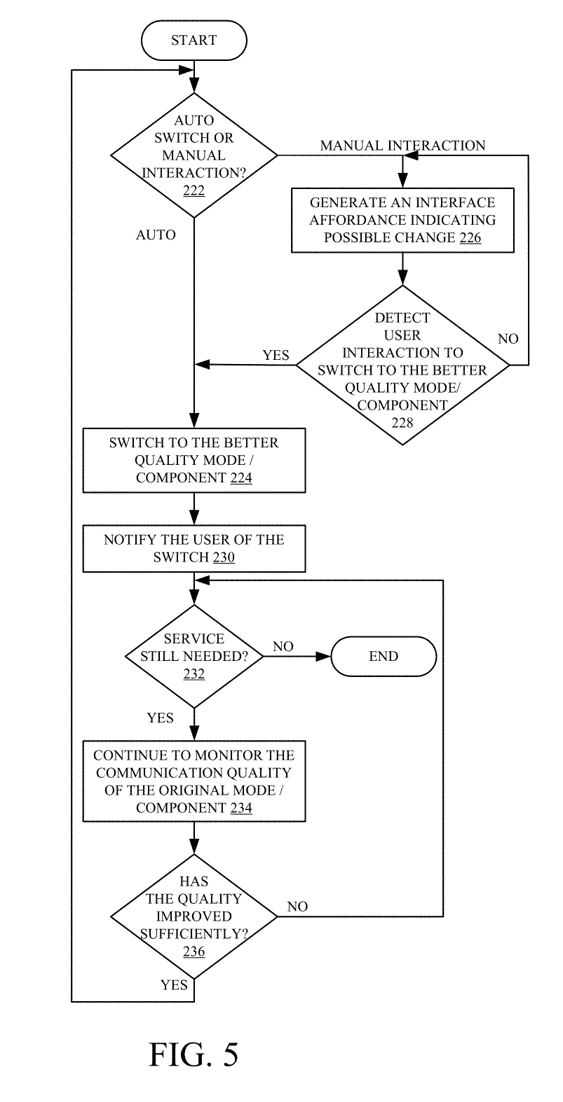

FIG. 5 is a block diagram showing one example of the communication mode switching, and monitoring for possible switchback (as represented by block 218 and 220 in FIG. 4). It is first assumed, with respect to FIG. 5, that it has been determined that the communication signal quality being experienced by the current communication component (e.g., component 160) does not meet the quality threshold. Therefore, a switch to another communication component (e.g., component 162) may be performed. In one example, the switching can be automated, in which case switching control system 178 automatically switches the application from using communication component 160 to using communication component 162. The switching may also use manual interaction. For instance, it may be that user interaction logic 176 generates a display or other user interface that suggests to user 110 that the user may experience better quality if the user switches to the newly identified communication component 162.

If the switch is automated, as determined at block 222, then switching control system 178 switches the application from using communication component 160 to using communication component 162. This is indicated by block 224. However, if, at block 222, it is determined that manual interaction is to be used, then user interaction logic 176 generates an interface affordance indicating a possible change. For instance, it can generate a user interface display, with a user actuatable element, that informs user 110 that the current communication quality using the Wi-Fi component (communication component 160) is relatively low quality, and asking whether the user wishes to launch a telephony application to communicate with speech service 116. Generating an interface affordance indicating a possible change, with a user actuable element, is indicated by block 226 in the flow diagram of FIG. 4.

User interaction logic 176 then illustratively detects, or uses user interface logic 148 to detect user interaction indicating that the user wishes to switch to the better quality communication component (e.g., to a cellular communication component 162). This is indicated by block 228. Again, processing continues at block 224 where switching control system 178 launches the telephony application and switches the application running on application running logic 146 to using the telephony application in order to obtain speech services from remote speech service 116.

User interaction logic 176 can also illustratively generate another interface or interface affordance that notifies user 110 that the switch has been made. This is indicated by block 230.

At some point, it may be that user 110 is no longer using the application that needs the remote speech service 116. If that is the case, the processing terminates. This is indicated by block 232. However, if the remote speech service 116 is still needed, then signal quality detection logic 154 illustratively continues to monitor the communication quality of the original communication component 160 to determine whether it improves. This is indicated by block 234. Thus, for instance, it keeps the Wi-Fi communication channel open and continues to send messages to identify the latency in that communication channel, or to identify the signal quality in other ways.

It then determines whether the signal quality has improved sufficiently to switch back to that communication component. For instance, it may be that communication component 160 is cheaper to run than communication component 162. Therefore, if signal quality detection logic 154 determines that the signal quality of communication component 160 has improved sufficiently, processing reverts to block 222 where it is determined whether the switch should take place automatically or with manual interaction. Determining whether the signal quality has improved sufficiently to possibly switch back to the original communication component 160 is indicated by block 236 in the flow diagram of FIG. 5.

It can thus be seen that the computing system, itself, is improved. Where multiple modes of communication are provided on the computing system, and where an application is accessing a remote service that has relatively high data throughput (such as a speech service) then the quality of the communication using a first communication component is detected and if it is low (e.g., if it falls below a threshold value), the communication component can be switched. This not only improves the performance of the computing system itself, because it improves the speed and quality of communication of the system, but it also greatly enhances the user experience.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

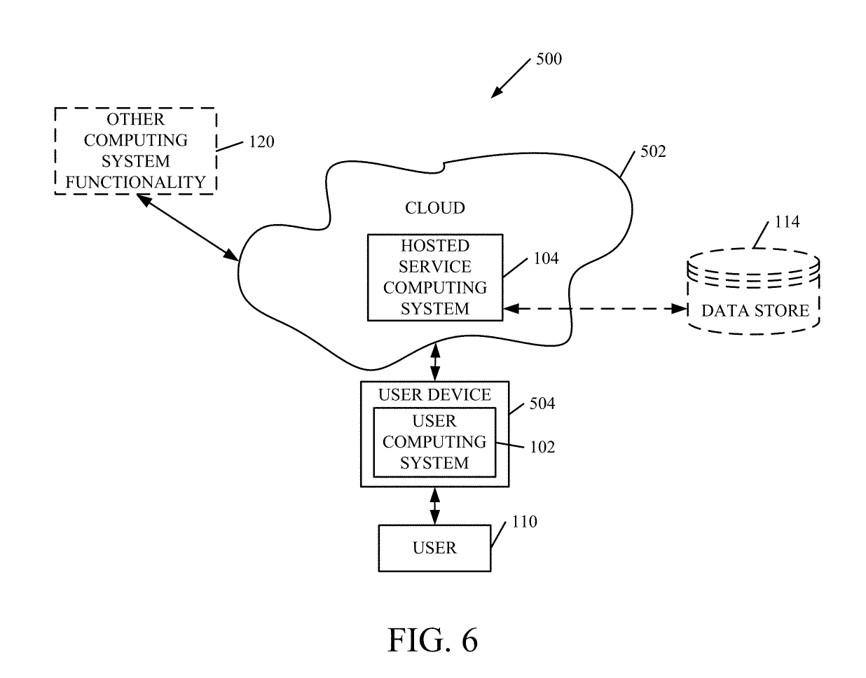

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that hosted service computing system 104 can be located in cloud 502 (which can be public, private, or a combination where portions are public while others are private). Therefore, user 110 uses a user device 504, which includes user computing system 102, to access those systems through cloud 502.

FIG. 6 also depicts another example of a cloud architecture. FIG. 6 shows that it is also contemplated that some elements of computing system 104 can be disposed in cloud 502 while others are not. By way of example, data store 114 can be disposed outside of cloud 502, and accessed through cloud 502. In another example, other computing system functionality 120 can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

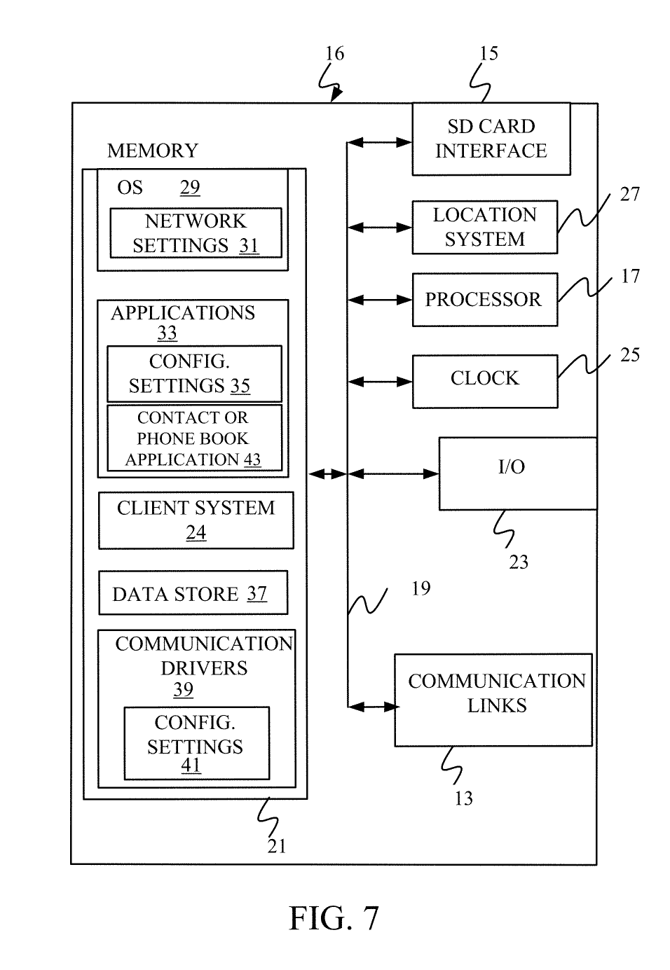

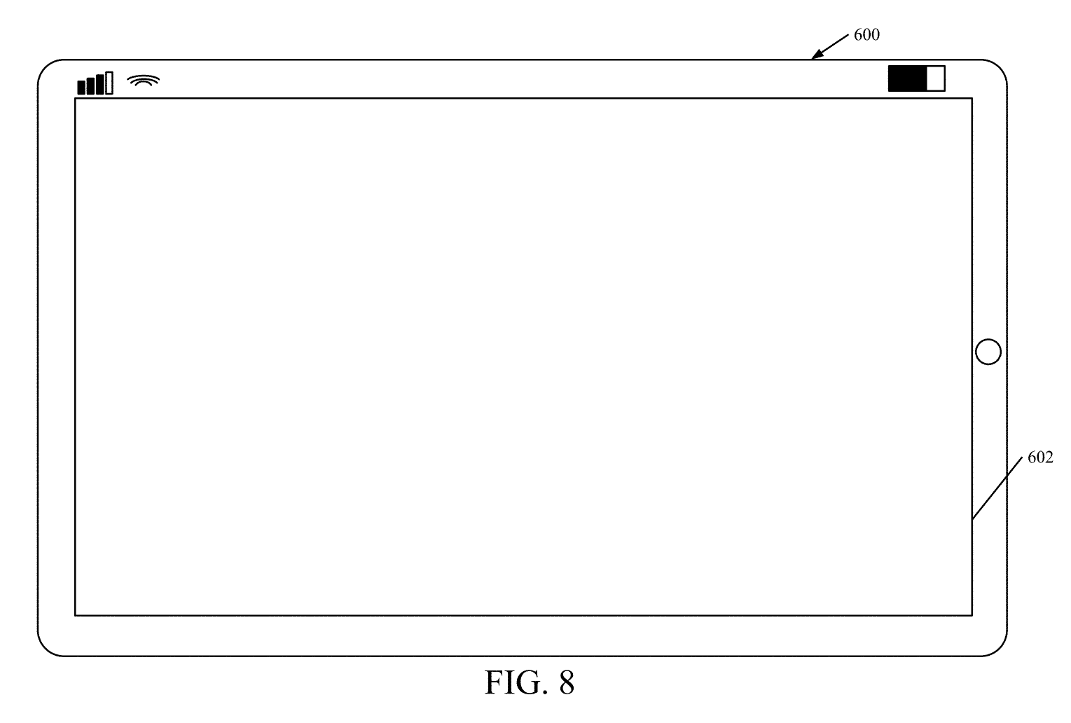

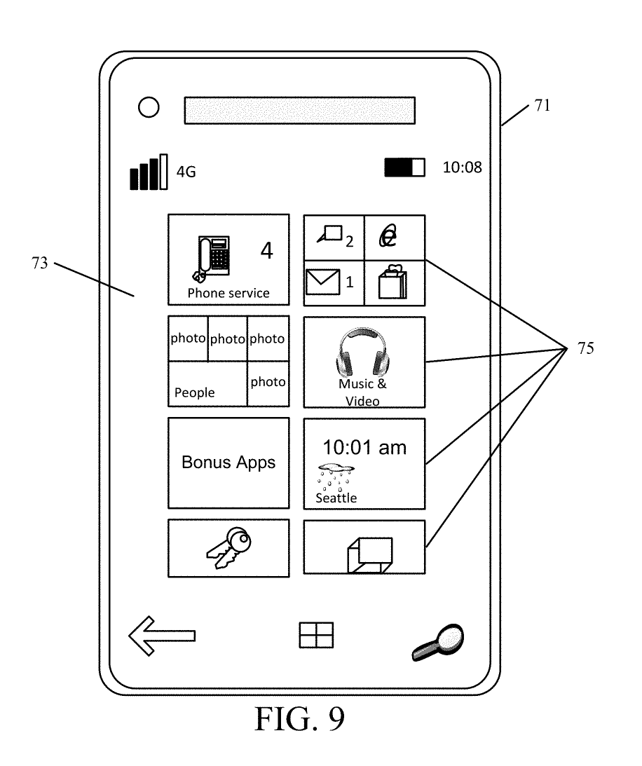

FIG. 7 is a simplified block diagram of one illustrative example of a handheld or mobile computing device that can be used as a user's or client's hand held device 16, that can act as user device 504. FIGS. 8-9 are examples of handheld or mobile devices.

FIG. 7 provides a general block diagram of the components of a client device 16 that can run components of computing system 102 or user device 504 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

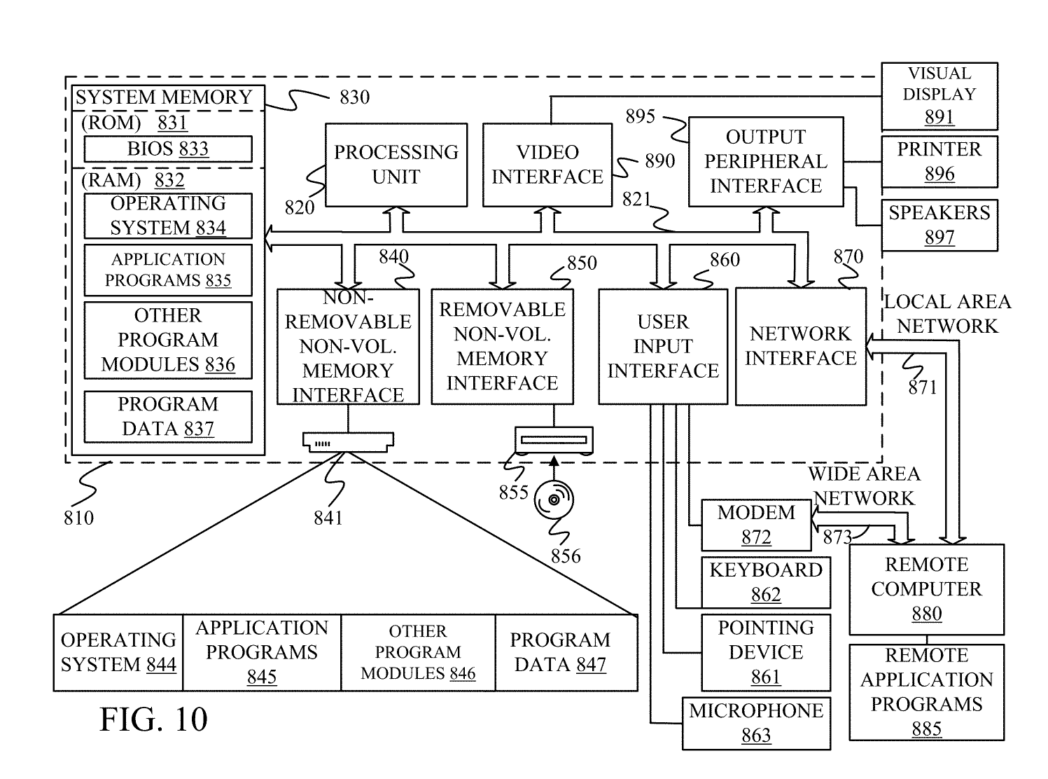

FIG. 10 is one example of a computing environment in which architecture 100, or parts of it, (for example) can be deployed. With reference to FIG. 10, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computing system, comprising:

a first communication component that communicates with a remote speech service;

application running logic that runs an application that accesses the remote speech service using the first communication component;

signal quality detection logic that detects a signal quality of a communication signal used by the first communication component; and

switching logic that performs a component switching operation to switch the application from using the first communication component to using a telephony communication component to communicate with the remote speech service, based on the detected signal quality.

Example 2 is the computing system of any or all previous examples wherein the signal quality detection logic comprises:

a signal characteristic detector configured to detect a characteristic of the communication signal indicative of signal quality.

Example 3 is the computing system of any or all previous examples wherein the signal quality detection logic comprises:

threshold comparison logic configured to compare the detected characteristic to a characteristic threshold to determine whether the detected characteristic meets the characteristic threshold and to generate a quality signal indicative of the comparison.

Example 4 is the computing system of any or all previous examples wherein the signal characteristic detector comprises:

latency detection logic that detects, as the characteristic of the communication signal, a latency value indicative of a latency in the communication signal between the first communication component and the remote speech service.

Example 5 is the computing system of any or all previous examples wherein the signal quality detection logic comprises:

signal strength measurement logic configured to measure, as the characteristic of the communication signal, a strength of the communication signal.

Example 6 is the computing system of any or all previous examples wherein the first communication component comprises:

a wireless local area network component (a WiFi component) configured to communicate with the remote speech service using an access point and a wide area network.

Example 7 is the computing system of any or all previous examples wherein the telephony communication component comprises:

a cellular communication component configured to communicate with the remote speech service using a cellular communication network.

Example 8 is the computing system of any or all previous examples wherein the switching logic comprises:

a switching control system configured to switch the application from using the WiFi component to using the cellular communication component.

Example 9 is the computing system of any or all previous examples wherein the switching logic comprises:

user interaction logic configured to surface, as part of the component switching operation, a user interface indicating a switch from the WiFi component to the cellular communication component, the user interface including a user actuatable element that is actuatable to approve the switch, the user interaction logic being configured to indicate to the switch control system that it should switch the application from using the WiFi component to using the cellular communication component, based on user actuation of the user actuatable element.

Example 10 is the computing system of any or all previous examples wherein the signal quality detection logic is configured to continue to detect signal quality of the communication signal used by the WiFi component after the application is switched to using the cellular communication component, and wherein the user interaction logic is configured to generate another user interface indicating a switch back to the WiFi component when the detected signal characteristic meets the characteristic threshold.

Example 11 is the computing system of any or all previous examples wherein the other user interface includes a user actuatable element that is actuatable to approve the switch back to the WiFi component, the user interaction logic being configured to indicate to the switch control system that it should switch the application from using the cellular communication component to using the WiFi component, based on user actuation of the user actuatable element.

Example 12 is a computer implemented method, comprising:

running an application that accesses a remote speech service using a first communication component;

detecting a signal quality of a communication signal used by the first communication component;

generating a first user interface indicating a switch from the first communication component to a telephony communication component, the user interface including a first user actuatable element that is actuatable to approve the switch;

detecting user actuation of the first user actuatable element;

switching the application from using the first communication component to using the telephony communication component, based on user actuation of the user actuatable element;

continuing to detect signal quality of the communication signal used by the first communication component after the application is switched to using the telephony communication component;

generating a second user interface indicating a switch back to the first communication component based on improvement in signal quality of the communication signal used by the first communication component, the second user interface including a second user actuatable element that is actuatable to approve the switch back to the first communication component; and

switching the application from using the telephony communication component to using the first communication component, based on user actuation of the second user actuatable element.

Example 13 is the computer implemented method of any or all previous examples wherein detecting the signal quality comprises:

detecting a characteristic of the communication signal indicative of signal quality.

Example 14 is the computer implemented method of any or all previous examples wherein detecting signal quality comprises:

comparing the detected characteristic to a characteristic threshold;

determining whether the detected characteristic meets the characteristic threshold based on the comparison; and

generating a quality signal indicative of the comparison.

Example 15 is the computer implemented method of any or all previous examples wherein detecting the signal characteristic comprises:

detecting a latency value indicative of a latency in the communication between the first communication component and the remote speech service.

Example 16 is the computer implemented method of any or all previous examples wherein detecting the signal characteristic comprises:

measuring a strength of the communication signal.

Example 17 is the computer implemented method of any or all previous examples wherein the first communication component comprises a wireless local area network component (a WiFi component) configured to communicate with the remote speech service using an access point and a wide area network and wherein the telephony communication component comprises a cellular communication component configured to communicate with the remote speech service using a cellular communication network and wherein switching the application from using the first communication component to using the telephony communication component comprises:

switching the application from using the WiFi component to using the cellular communication component.

Example 18 is the computer implemented method of any or all previous examples wherein switching the application from using the telephony communication component to using the first communication component, based on user actuation of the second user actuatable element logic comprises:

detecting user actuation of the second user actuatable element; and

controlling the application to switch the application from using the WiFi component to using the cellular communication component, based on user actuation of the second user actuatable element.

Example 19 is a computing system, comprising:

a first communication component that communicates with a remote speech service;

application running logic that runs an application that accesses the remote speech service using the communication component;

signal quality detection logic that detects a signal quality of a communication signal used by the first communication component; and

switching logic that performs a component switching operation to switch the application from using the first communication component to using a telephony communication component to communicate with the remote speech service, based on the detected signal quality, wherein the signal quality detection logic is configured to continue to detect signal quality of the communication signal used by the first communication component after the application is switched to using the telephony communication component, and wherein the switching logic is configured to generate a user interface indicating a switch back to the first communication component based on improvement in the detected signal quality of the communication signal used by the first communication component.

Example 20 is the computing system of any or all previous examples wherein the first communication component comprises a WiFi component and wherein the telephony communication component comprises a cellular communication component and wherein the user interface includes a user actuatable element that is actuatable to approve the switch back to the WiFi component, the switching logic being configured to switch the application from using the cellular communication component to using the WiFi component, based on user actuation of the user actuatable element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing system, comprising:
a first communication component configured to communicate with a remote speech service;
application running logic configured to run an application that accesses the remote speech service using the first communication component;
signal quality detection logic configured to detect a signal quality of a communication signal used by the first communication component; and
switching logic configured to:
based on the detected signal quality, generate a user interface that
indicates a component switching operation to switch the application from using the first communication component to using a telephony communication component to communicate with the remote speech service, and
includes a user actuatable element;
receive an indication of user actuation of the user actuatable element indicating user approval of the component switching operation; and
based on the user approval, perform the component switching operation;
wherein the application is configured to:
receive a user input;
generate user input data indicative of the user input; and
based on the component switching operation, send the user input data to the remote speech service and receive response data indicative of the remote speech service processing the user input data.

2. The computing system of claim 1 wherein the user input comprises a speech input and the user input data comprises speech data indicative of the speech input, and the application is configured to:
based on the switch, send the speech data to the remote speech service using the telephony communication component; and
receive response data indicative of the remote speech service processing the speech data.

3. The computing system of claim 1 wherein the signal quality detection logic comprises:
a signal characteristic detector configured to detect a characteristic of the communication signal indicative of signal quality; and
threshold comparison logic configured to compare the detected characteristic to a characteristic threshold to determine whether the detected characteristic meets the characteristic threshold and to generate a quality signal indicative of the comparison.

4. The computing system of claim 3 wherein the signal characteristic detector comprises:
latency detection logic configured to detect, as the characteristic of the communication signal, a latency value indicative of a latency in the communication signal between the first communication component and the remote speech service.

5. The computing system of claim 3 wherein the signal quality detection logic comprises:
signal strength measurement logic configured to measure, as the characteristic of the communication signal, a strength of the communication signal.

6. The computing system of claim 3 wherein the first communication component comprises:
a wireless local area network component (a WiFi component) configured to communicate with the remote speech service using an access point and a wide area network.

7. The computing system of claim 6 wherein the telephony communication component comprises:
a cellular communication component configured to communicate with the remote speech service using a cellular communication network; and
wherein the switching logic comprises:
a switching control system configured to switch the application from using the WiFi component to using the cellular communication component.

8. The computing system of claim 1 wherein the switching logic is configured to perform the component switching operation by switching to a phone application.

9. The computing system of claim 7 wherein the user interface indicates a switch from the WiFi component to the cellular communication component.

10. The computing system of claim 9 wherein the signal quality detection logic is configured to continue to detect signal quality of the communication signal used by the WiFi component after the application is switched to using the cellular communication component, and wherein the switching logic is configured to generate another user interface indicating a switch back to the WiFi component when the detected signal characteristic meets the characteristic threshold.

11. The computing system of claim 10 wherein the other user interface includes a user actuatable element that is actuatable to approve the switch back to the WiFi component, the switching logic being configured to switch the application from using the cellular communication component to using the WiFi component, based on user actuation of the user actuatable element.

12. A computer implemented method, comprising:
running an application that accesses a remote speech service using a first communication component;
detecting a signal quality of a communication signal used by the first communication component;
generating a first user interface indicating a switch from the first communication component to a telephony communication component, the user interface including a first user actuatable element that is actuatable to approve the switch;
detecting user actuation of the first user actuatable element;
switching the application from using the first communication component to using the telephony communication component, based on user actuation of the first user actuatable element;
continuing to detect signal quality of the communication signal used by the first communication component after the application is switched to using the telephony communication component;
generating a second user interface indicating a switch back to the first communication component based on improvement in signal quality of the communication signal used by the first communication component, the second user interface including a second user actuatable element that is actuatable to approve the switch back to the first communication component; and
switching the application from using the telephony communication component to using the first communication component, based on user actuation of the second user actuatable element.

13. The computer implemented method of claim 12 wherein detecting the signal quality comprises:
detecting a characteristic of the communication signal indicative of signal quality.

14. The computer implemented method of claim 13 wherein detecting signal quality comprises:
comparing the detected characteristic to a characteristic threshold;
determining whether the detected characteristic meets the characteristic threshold based on the comparison; and
generating a quality signal indicative of the comparison.

15. The computer implemented method of claim 14 wherein detecting the signal characteristic comprises:
detecting a latency value indicative of a latency in the communication signal between the first communication component and the remote speech service.

16. The computer implemented method of claim 14 wherein detecting the signal characteristic comprises:
measuring a strength of the communication signal.

17. The computer implemented method of claim 14 wherein the first communication component comprises a wireless local area network component (a WiFi component) configured to communicate with the remote speech service using an access point and a wide area network and wherein the telephony communication component comprises a cellular communication component configured to communicate with the remote speech service using a cellular communication network and wherein switching the application from using the first communication component to using the telephony communication component comprises:
switching the application from using the WiFi component to using the cellular communication component.

18. The computer implemented method of claim 17 wherein switching the application from using the telephony communication component to using the first communication component, based on user actuation of the second user actuatable element logic comprises:
detecting user actuation of the second user actuatable element; and
controlling the application to switch the application from using the WiFi component to using the cellular communication component, based on user actuation of the second user actuatable element.

19. A computing system, comprising:
a first communication component that communicates with a remote speech service;
application running logic that runs an application that accesses the remote speech service using the first communication component;
signal quality detection logic that detects a signal quality of a communication signal used by the first communication component; and
switching logic that performs a component switching operation to switch the application from using the first communication component to using a telephony communication component to communicate with the remote speech service, based on the detected signal quality, wherein the signal quality detection logic is configured to continue to detect signal quality of the communication signal used by the first communication component after the application is switched to using the telephony communication component, and wherein the switching logic is configured to generate a user interface indicating a switch back to the first communication component based on improvement in the detected signal quality of the communication signal used by the first communication component.

20. The computing system of claim 19 wherein the first communication component comprises a WiFi component and wherein the telephony communication component comprises a cellular communication component and wherein the user interface includes a user actuatable element that is actuatable to approve the switch back to the WiFi component, the switching logic being configured to switch the application from using the cellular communication component to using the WiFi component, based on user actuation of the user actuatable element.
